(19) United States
(12) Patent Application Publication
(10) Pub. No.: US 2016/0309002 A1
(43) Pub. Date: Oct. 20, 2016

(54) TERMINAL DEVICE, TERMINAL DEVICE CONTROL METHOD, AND STORAGE MEDIUM

(71) Applicant: NEC Corporation, Minato-ku, Tokyo (JP)

(72) Inventor: Toshinori TAKEMURA, Tokyo (JP)

(73) Assignee: NEC Corporation, Minato-ku, Tokyo (JP)

(21) Appl. No.: 14/778,186

(22) PCT Filed: Mar. 14, 2014
(86) PCT No.: PCT/JP2014/001465

§ 371 Date: Sep. 18, 2015

(30) Foreign Application Priority Data
Apr. 2, 2013 (JP) 2013-076734

(51) Int. Cl. H04L 29/08; G06F 9/54; G06F 3/0481

(52) U.S. Cl. CPC H04L 67/34; H04L 67/10; H04L 67/141; G06F 3/04817; G06F 9/547; G06F 2209/549

(57) ABSTRACT

An objective of the present invention is to improve user operability when the user operates a plurality of applications which are executed with each of a plurality of nodes, using one terminal device. A terminal device which is connected to be capable of communication with a plurality of nodes includes a screen display unit which displays one screen including an instruction unit that instructs an execution of an application which is executed upon a first node among the plurality of nodes and an instruction unit that instructs an execution of an application which is executed upon a second node among the plurality of nodes; an operation accepting unit which accepts an operation for the instruction unit included in the screen; and a transmission unit which transmits commands for executing the applications corresponding to the operated instruction unit to the nodes whereupon the applications are to be executed.

### TECHNICAL FIELD

The present invention relates to a terminal device, a terminal device control method, and a storage medium.

### BACKGROUND ART

PTL 1 discloses that a plurality of servers connected to a terminal device are remotely operated from the terminal device via a communication network (hereinafter, abbreviated as a “network” in the present application). PTL 1 further discloses a technique for displaying a “connection destination selecting screen” on a screen of the terminal device. The “connection destination selecting screen” disclosed in PTL 1 is a screen for allowing a user to select a server to be remotely operated by the terminal device from among the plurality of servers connected to the network.

NPL 1 discloses a remote desktop function with which a user is allowed to concurrently log into a plurality of personal computers. NPL 1 further discloses a user interface in the remote desktop function. In the user interface disclosed in NPL 1, a user operates a tab displayed on a screen. According to this configuration, a user can switch to display a desktop screen associated with a personal computer among the plurality of personal computers concurrently logged in.

### CITATION LIST

### Patent Literature

[PTL 1] Japanese Laid-open Patent Publication No. 2005-148893

### Non Patent Literature

[NPL1] Vector, “MBC Remote Desktop”, [online] Jul. 28, 2011, Vector, [searched on Feb. 15, 2013], Internet <URL: http://www.vector.co.jp/magazine/softnews/110728/n1107282.html>

### SUMMARY OF INVENTION

### Technical Problem

A user logs into a plurality of nodes from a terminal device, and operates a plurality of applications to be executed on each of the plurality of nodes, using the terminal device. For instance, the user first operates the application A to be executed on the first node, and then operates the application B to be executed on the second node, using the terminal device.

The technique disclosed in PTL 1 forces a user to perform a cumbersome operation. According to the technique disclosed in PTL 1, a user is required to select a node to be activated on the connection destination selecting screen, each time the node to be activated is switched from the first node to the second node.

The technique disclosed in NPL 1 also forces a user to perform a cumbersome operation. According to the technique disclosed in NPL 1, a user first performs an operation of switching the node to be activated from the node 1 to the node 2. Then, the user performs an operation of selecting the application B from among a plurality of applications to be executed on the node 2. In this way, according to the technique disclosed in NPL 1, the user is forced to individually perform two different operations i.e. the operation of selecting a node to be activated, and the operation of selecting an application to be executed.

An object of the present invention is to provide a terminal device with enhanced user's operability, and the like, when the user operates a plurality of applications to be executed on each of the plurality of nodes, using one terminal device.

### Solution to Problem

According to a first aspect, the present invention provides a terminal device communicatively connected to a plurality of nodes includes:

a screen display unit that displays one screen including an instruction unit instructing to execute an application to be executed on a first node out of the plurality of nodes, and an instruction unit instructing to execute an application to be executed on a second node out of the plurality of nodes;

operation accepting unit that accepts an operation with respect to the instruction unit included in the screen; and

transmitting unit that transmits a command for instructing to execute the application associated with the operated instruction unit to the node on which the application is to be executed.

According to a second aspect, the present invention provides a method for controlling a terminal device connected communicatively to a plurality of nodes, the method includes:

displaying one screen including an instruction unit instructing to execute an application to be executed on a first node out of the plurality of nodes, and an instruction unit instructing to execute an application to be executed on a second node out of the plurality of nodes;

accepting an operation with respect to the instruction unit included in the screen; and

transmitting a command for instructing to execute the application associated with the operated instruction unit to the node on which the application is to be executed.

According to a third aspect, the present invention provides a non-transitory computer-readable storage medium stored with a program which causes a terminal device connected communicatively to a plurality of nodes to execute:

processing of displaying one screen including an instruction unit instructing to execute an application to be executed on a first node out of the plurality of nodes, and an instruction unit instructing to execute an application to be executed on a second node out of the plurality of nodes;

processing of accepting an operation with respect to the instruction unit included in the screen; and

processing of transmitting a command for instructing to execute the application associated with the operated instruction unit to the node on which the application is to be executed.

The object of the present invention is also achieved by a computer-readable storage medium stored with the aforementioned program.

### Advantageous Effects of Invention

According to the present invention, it is possible to enhance the user's operability when the user operates a plurality of applications to be executed on each of the plurality of nodes, using one terminal device.

### BRIEF DESCRIPTION OF DRAWINGS

FIG. 1 is a block diagram illustrating the entire configuration of an information processing system 1000 according to a first exemplary embodiment of the present invention.

FIG. 2 is a diagram illustrating an example of the hardware configuration of a terminal device 100 according to the present invention.

FIG. 3 is a diagram illustrating an example of a screen to be displayed by a screen display unit 113 according to the first exemplary embodiment of the present invention.

FIG. 4 is a sequence diagram illustrating an operation to be performed by the information processing system 1000 according to the first exemplary embodiment of the present invention.

FIG. 5 is a reference diagram describing a problem to be solved by the present invention.

FIG. 6 is a diagram illustrating an example of a screen to be displayed by the screen display unit 113 according to the first exemplary embodiment of the present invention.

FIG. 7 is a diagram illustrating an example of a screen to be displayed by the screen display unit 113 according to the first exemplary embodiment of the present invention.

FIG. 8 is a diagram illustrating an example of a screen to be displayed by the screen display unit 113 according to the first exemplary embodiment of the present invention.

FIG. 9 is a block diagram illustrating the entire configuration of an information processing system 1000A according to a second exemplary embodiment of the present invention.

FIG. 10 is a diagram illustrating an example of an icon to be displayed by a screen display unit 123 according to the second exemplary embodiment of the present invention.

FIG. 11 is a diagram illustrating an example of a screen to be displayed by the screen display unit 123 according to the second exemplary embodiment of the present invention.

FIG. 12 is a sequence diagram illustrating an operation to be performed by the information processing system 1000A according to the second exemplary embodiment of the present invention.

FIG. 13 is a diagram illustrating an example of a screen to be displayed by the screen display unit 123 according to the second exemplary embodiment of the present invention.

FIG. 14 is a block diagram illustrating a configuration of a terminal device 102 according to a third exemplary embodiment of the present invention.

### DESCRIPTION OF EMBODIMENTS

A problem to be solved by the present invention is described in detail in order to facilitate understanding of the present invention.

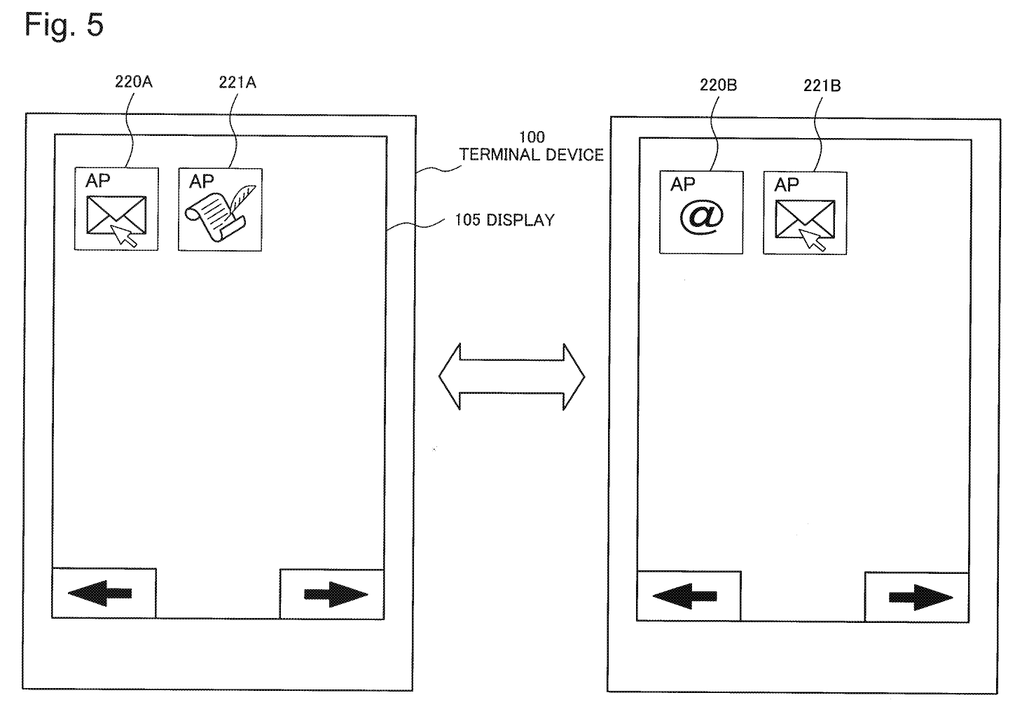

FIG. 5 is a reference diagram for describing the problem to be solved by the present invention. The screen illustrated in FIG. 5 is a menu screen to be displayed on a display 105 provided in a terminal device 100 when the terminal device 100 is concurrently connected to two nodes (200A and 200B). The screen illustrated in FIG. 5 is a screen assuming that the terminal device 100 is a smartphone. The screen illustrated in FIG. 5 is a menu screen that is displayed by a method different from the method of the present invention.

The menu screen illustrated on the left portion in FIG. 5 includes icons representing applications (AP220A and AP221A) to be executed on one node (200A) out of the two nodes. The menu screen illustrated on the right portion in FIG. 5 includes icons representing applications (AP220B and 221B) to be executed on the other node (200B) of the two nodes. In order to switch between the menu screen illustrated on the left portion in FIG. 5, and the menu screen illustrated on the right portion in FIG. 5, the user of the terminal device 100 performs an operation such as flicking the display 105, for instance.

It is assumed that the user can work, while switching between the two nodes (200A and 200B) by the terminal device 100. For instance, it is assumed that the user first operates the application 220A to be executed on the node 200A, and then, operates the application 221B to be executed on the node 200B, using the terminal device 100. The following is a description as to how the user operates the menu screens illustrated in FIG. 5 in performing the aforementioned operation.

The user terminates the application 220A to be executed on the node 200A. Then, the menu screen illustrated on the left portion in FIG. 5 is displayed on the display 105. First of all, the user performs a first operation of switching the node to be activated from the node 200A to the node 200B. The first operation is, for instance, flicking the display 105. Then, the indication of the display 105 is switched from the menu screen illustrated on the left portion in FIG. 5 to the menu screen illustrated on the right portion in FIG. 5. The user performs a second operation of selecting the application 221B on the menu screen illustrated on the right portion in FIG. 5. Then, the application 221B is activated.

As described above, when the user operates the menu screens illustrated in FIG. 5, the user is forced to perform two different operations individually. The two different operations are, in other words, the first operation of selecting a node to be activated from among a plurality of nodes, and the second operation of selecting an application to be executed from among a plurality of applications to be executed on the node selected by the first operation. Performing the two different operations individually is cumbersome to the user.

Next, exemplary embodiments of the present invention are described in detail referring to the drawings.

### First Exemplary Embodiment

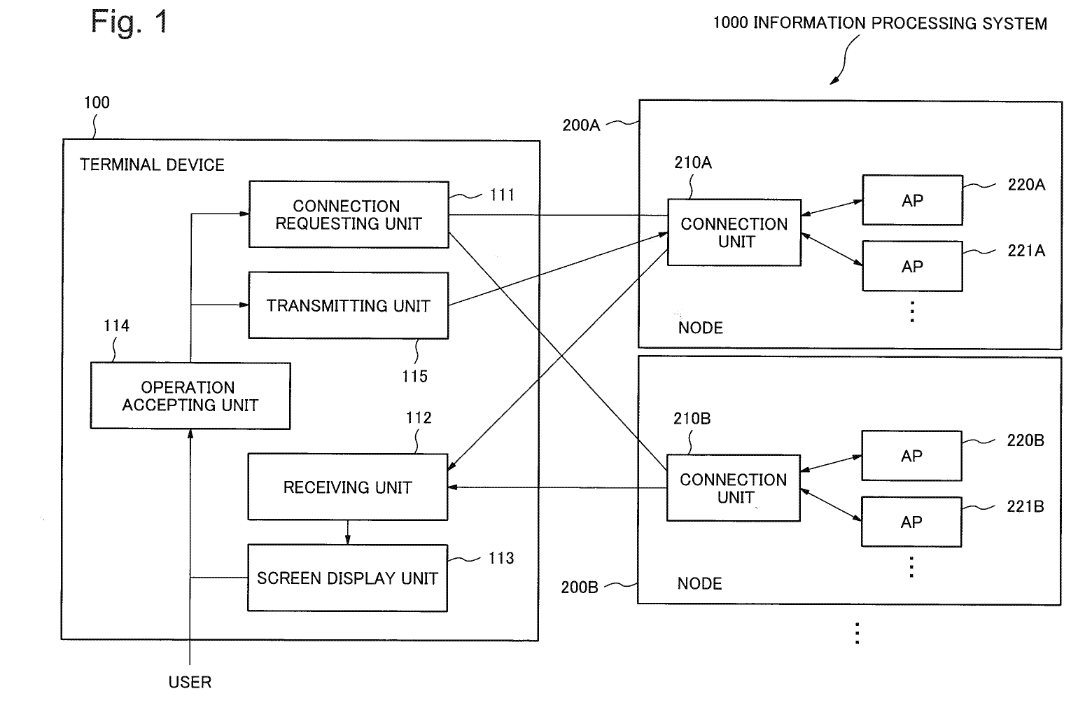

FIG. 1 is a block diagram illustrating an entire configuration of an information processing system 1000 provided with a terminal device 100 according to the first exemplary embodiment. As illustrated in FIG. 1, the information processing system 1000 is provided with the terminal device 100, and a plurality of nodes 200A and 200B. The terminal device 100 is provided with a function of operating the plurality of nodes 200A and 200B via a network. In FIG. 1, two nodes are illustrated. The number of nodes, however, is not limited to two. The node 200A illustrated in FIG. 1 is provided with a connection unit 210A, and a plurality of applications 220A to be executed on the node 200A. In the following, when it is necessary to differentiate the plurality of applications 220A from one another, the applications are described as an application 220A and an application 221A. In FIG. 1, two applications are illustrated in the node 200A, but the number of applications is not limited to two.

The node 200B illustrated in FIG. 1 is provided with a connection unit 210B, and a plurality of applications 220B to be executed on the node 200B. In the following, when it is necessary to differentiate the plurality of applications 220B from one another, the applications are described as an application 220B and an application 221B. In FIG. 1, two applications are illustrated in the node 200B, but the number of applications is not limited to two.

In the following, when it is not necessary to differentiate the node 200A and the node 200B from each other, the nodes may be generically described as nodes 200 in order to simplify the description. Likewise, when it is not necessary to differentiate the connection units 210A and 210B from each other, the connection units may be generically described as connection units 210 in order to simplify the description. Likewise, when it is not necessary to differentiate the applications 220A and 220B from each other, the applications may be generically described as applications 220 in order to simplify the description.

The connection unit 210 is provided with a session management function to be executed when the node 200 communicates with the terminal device 100, and the like. The application 220 is an application to be executed on the node 200. The application 220 includes, for instance, a mail application, a document creating application, a browser application, and the like.

The terminal device 100 is provided with a connection requesting unit 111, a receiving unit 112, a screen display unit 113, an operation accepting unit 114, and a transmitting unit 115.

The operation accepting unit 114 accepts a connection request to the node 200 from a user.

The connection requesting unit 111 is provided with a session management function capable of providing a concurrent connection function with respect to the nodes 200, and the like. The concurrent connection function is a function capable of allowing the terminal device 100 to log into the plurality of nodes 200 substantially at the same time, and capable of allowing a user to concurrently operate the plurality of nodes 200 through the terminal device 100. This function includes a function capable of performing parallel operations in a pseudo manner. When a connection request is accepted via the operation accepting unit 114, the connection requesting unit 111 transmits the connection request to each of the plurality of nodes 200 in order to concurrently log into the plurality of nodes 200.

The receiving unit 112 receives, from each of the plurality of nodes 200 to which the terminal device 100 logs in, an identifier of each of the applications 220 to be executed on the node, and each icon for use in instructing to execute the application represented by the identifier.

The screen display unit 113 displays a menu screen on the display 105. For instance, it is assumed that the terminal device 100 logs into two nodes i.e. the node 200A and the node 200B. In this case, the menu screen includes at least an icon capable of instructing to execute the application 220A to be executed on the node 200A, and an icon capable of instructing to execute the application 220B to be executed on the node 200B. For instance, when a plurality of applications 220A are executed on the node 200A, the menu screen includes the icons capable of instructing to execute the respective applications among the plurality of applications (AP220A, AP221A, . . . ).

The operation accepting unit 114 further accepts a user's operation with respect to an icon included in the menu screen. The user's operation is, for instance, a tap operation, a flick operation, or a drag operation with respect to an icon displayed on the display 105. When the display is not constituted by a touch panel, the user's operation may be a click operation using a cursor or the like. The user's operation may be also an operation via a button or a switch provided in the terminal device 100.

The operation accepting unit 114 discriminates an application associated with an operated icon, and a command for executing the application, based on the accepted operation from the user.

A practical example of the above case is described. For instance, the user performs the tap operation with respect to the icon displayed on the display 105. Then, the operation accepting unit 114 accepts the operation of tapping a specific position on the menu screen. The operation accepting unit 114 discriminates an application to be executed, based on the information representing the tapped position, for instance. Further, the operation accepting unit 114 discriminates the command for executing the application, based on the type of the accepted operation such as the tap operation, for instance.

The transmitting unit 115 transmits the command for executing the application discriminated by the operation accepting unit 114 to the node on which the application is to be executed.

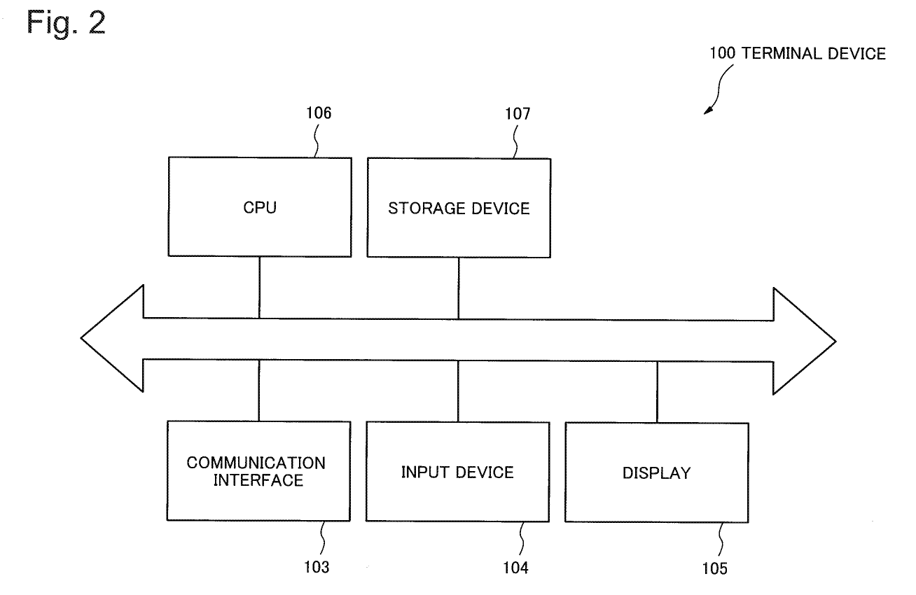

FIG. 2 is a diagram illustrating an example of the hardware configuration of the terminal device 100 illustrated in FIG. 1. As illustrated in FIG. 2, the terminal device (an information processing device or a computer) 100 is provided with a CPU (Central Processing Unit) 106, a storage device 107, a communication interface 103, an input device 104, and the display 105. The terminal device 100 is implemented by, for instance, a terminal for business use, a personal computer, a tablet mobile terminal, a smartphone, a game device provided with a communication function, and the like. A part or all of the functions of the terminal device 100 is implemented by, for instance, causing the CPU 106 to execute a program (an application program or a software program) read out to the storage device 107. The input device 104 is, for instance, a keyboard, a mouse, or a button, and the like. The input device 104 and the display 105 may be constituted as one unit, for instance, like a touch panel.

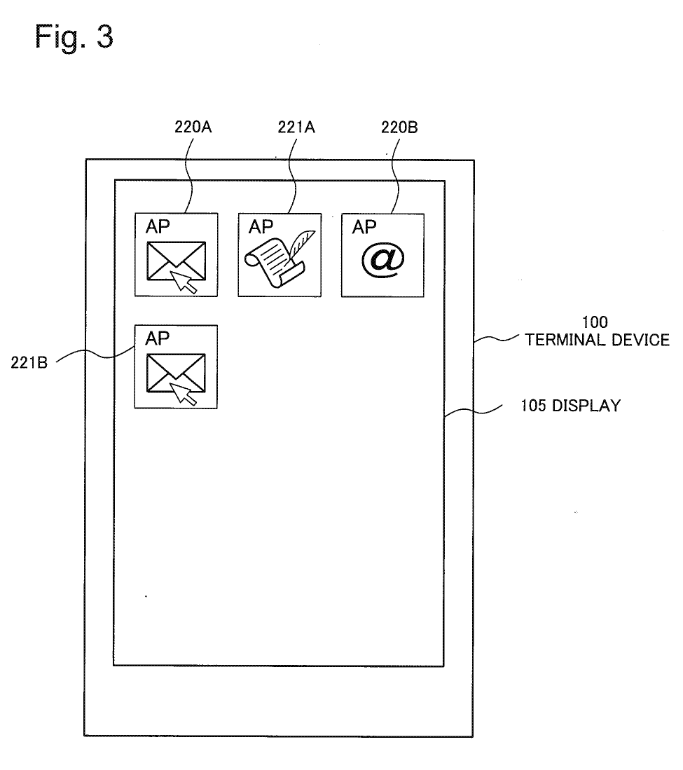

FIG. 3 is a diagram illustrating an example of a menu screen to be displayed on the display 105 by the screen display unit 113. The screen illustrated in FIG. 3 is a screen supposing the case when the terminal device 100 is a smartphone. As illustrated in FIG. 3, the screen display unit 113 displays, on the display, one menu screen including the icons (in this example, four icons) capable of instructing to execute the applications (AP220A and AP221A) to be executed on the node 200A, and the applications (AP220B and AP221B) to be executed on the node 200B.

The icons (e.g. AP220A and AP220B) received from at least the two nodes (200A and 200B) are concurrently displayed on the menu screen. Further, as illustrated in FIG. 3, at least two icons (AP220A and AP221A) are concurrently displayed with respect to one node (e.g. 200A) on the menu screen.

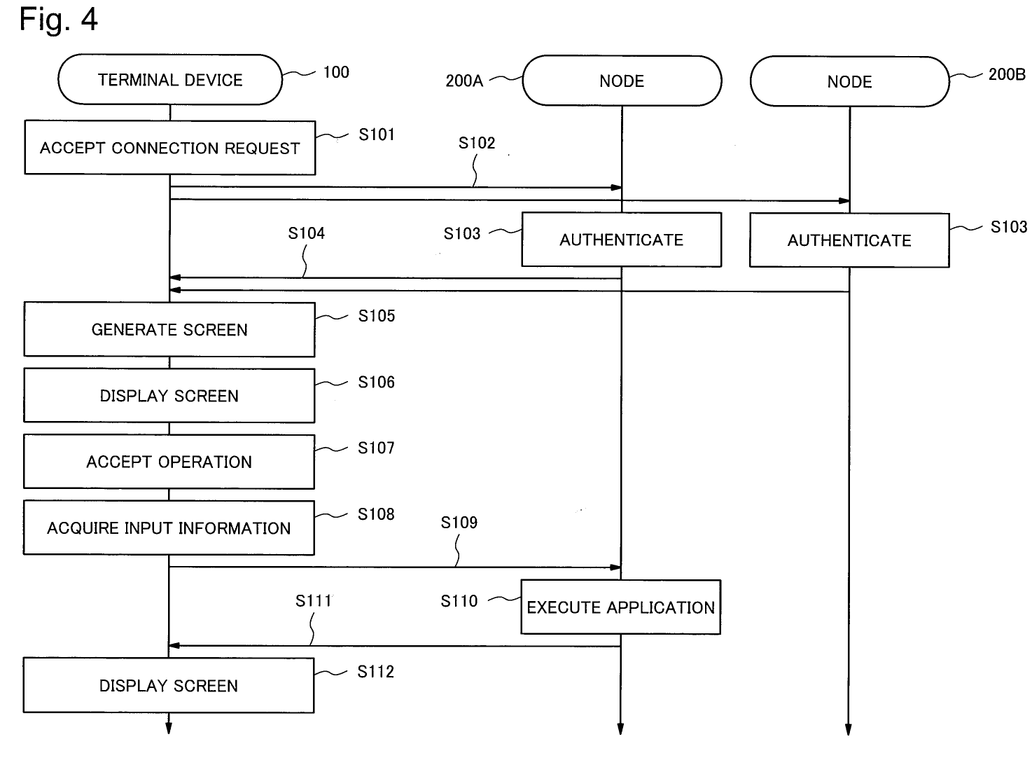

Next, the overall operation to be performed by the information processing system 1000 illustrated in FIG. 1 is described using FIG. 4. FIG. 4 is a sequence diagram illustrating the overall operation to be performed by the information processing system 1000.

The connection requesting unit 111 accepts the connection request to the node 200 via the operation accepting unit 114 (S101). For instance, when the connection requesting unit 111 accepts the connection requests to the node 200A and to the node 200B from the user, the connection requesting unit 111 transmits the connection request to each of the node 200A and the node 200B (S102). The connection unit 210 provided in the node 200 receives the connection request from the terminal device 100, and performs authentication processing with respect to the terminal device 100 (S103). When the authentication is successful, the terminal device 100 is brought to a logged-in state with respect to the node 200. The logged-in node 200 transmits, to the terminal device 100, the identifier of the application to be executed on the node 200, and the icon for use in instructing to execute the application in association with each other (S104). The receiving unit 112 provided in the terminal device 100 receives the information transmitted from the node 200.

The screen display unit 113 generates the menu screen including the received icon (S105), and displays the generated screen on the display 105 (S106).

The operation accepting unit 114 accepts the user's operation with respect to the icon included in the menu screen (S107). The operation accepting unit 114 discriminates the application, and the command for instructing to execute the application, based on the accepted operation (S108).

The transmitting unit 115 transmits the command for instructing to execute the application to the node 200 on which the application is to be executed (S109).

The connection unit 210 provided in the node 200 receives the information transmitted from the transmitting unit 115 provided in the terminal device 100. The node 200 executes the application (application 220) based on the received command (S110). The connection unit 210 provided in the node 200 transmits a screen displaying a result of activation of the application 220 to the receiving unit 112 in the terminal device 100 (S111). The receiving unit 112 receives the screen transmitted from the connection unit 210. The screen display unit 113 outputs the screen received by the receiving unit 112 to the display 105 (S112).

Next, the advantageous effects of the terminal device 100 according to the first exemplary embodiment are described. The user works while switching the node between the node 200A and the node 200B by the terminal device 100. For instance, the user first operates the application 220A to be executed on the node 200A, and then operates the application 221B to be executed on the node 200B, using the terminal device 100. The following is a description as to how the user operates the menu screen illustrated in FIG. 3 in performing the aforementioned operation.

The user terminates execution of the application 220A to be executed on the node 200A. Then, the menu screen illustrated in FIG. 3 is displayed on the display 105. The user performs an operation of selecting the application 221B on the menu screen illustrated in FIG. 3. Then, the application 221B is activated in response to the user's operation. In this way, when the user operates the menu screen illustrated in FIG. 3, the user can perform the operation of switching the node to be activated, and selecting the application to be executed by one-time operation. Switching the node to be activated is, in other words, selecting the node 200B of the node 200A and the node 200B. Selecting the application to be executed is, in other words, selecting the application 221B of the application 220B and the application 221B. Reducing the number of times of operations leads to enhancement of the user's operability.

According to the terminal device 100 according to the first exemplary embodiment, it is possible to enhance the user's operability when the user operates a plurality of applications to be executed on each of the plurality of nodes, using one terminal device.

Further, the terminal device 100 according to the first exemplary embodiment makes it possible for the user to operate the plurality of applications 220 to be executed on the plurality of nodes 200 through the terminal device 100, without considering which application 220 is to be executed on which one of the nodes 200. For instance, even when different OSs (Operating Systems) are installed in each of the node 200A and in the node 200B, the user of the terminal device 100 can operate the applications 220 to be executed by the different OSs on one menu screen, without considering the difference between the OSs.

The connection requesting unit 111 may be configured to automatically transmit the connection request to the plurality of nodes 200 stored in advance, in response to accepting the connection request from the user. According to the aforementioned configuration, the user can operate the plurality of nodes using the terminal device 100, without considering the presence of the plurality of nodes throughout the time from transmission of the connection request to execution of the application.

The terminal device 100 according to the first exemplary embodiment is applicable to a BYOD (Bring Your Own Device), for instance. BYOD is an abbreviated term which expresses a manner of using a mobile terminal, according to which a mobile terminal owned by the individual is used separately for personal use and for business use. For instance, the node 200A may provide a mobile phone function for personal use by the user, and the node 200B may provide a mobile phone function for business use by the user. When the user operates the application 220, communication and data are isolated between the node 200A and the node 200B. Therefore, the terminal device 100 according to the first exemplary embodiment makes it possible to prevent information leakage between the node 200A and the node 200B, and further to separately manage charges such as communication fees between the node 200A and the node 200B.

The screen display unit 113 according to the first exemplary embodiment displays one screen including instruction means for instructing to execute a plurality of applications to be executed on each of the plurality of nodes. Therefore, the screen display unit 113 is capable of displaying the menu screen with enhanced operability, even when the terminal device 100 does not have a multi-window function.

### Modified Example of First Exemplary Embodiment

Icons are merely an example of the instruction means for instructing to execute applications. The instruction means may be, for instance, radio buttons, pull-down menus, widgets, or objects, other than the icons.

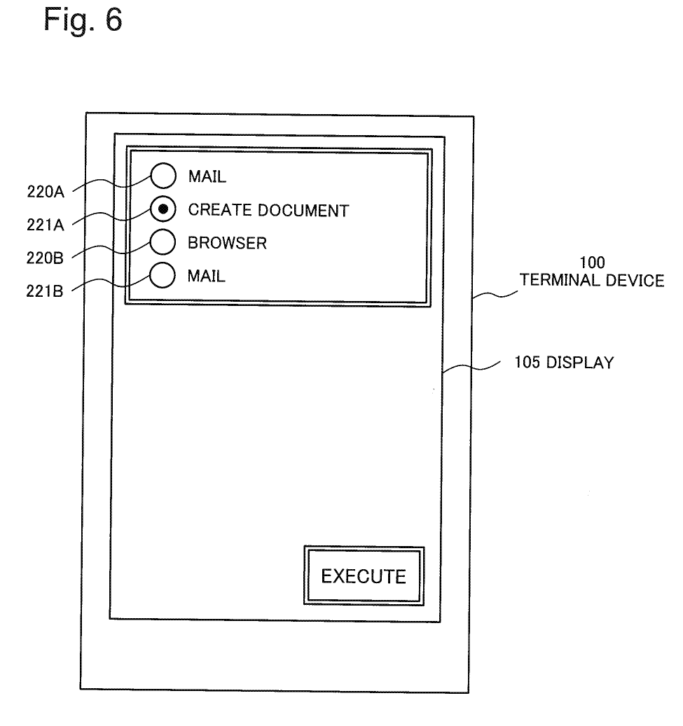

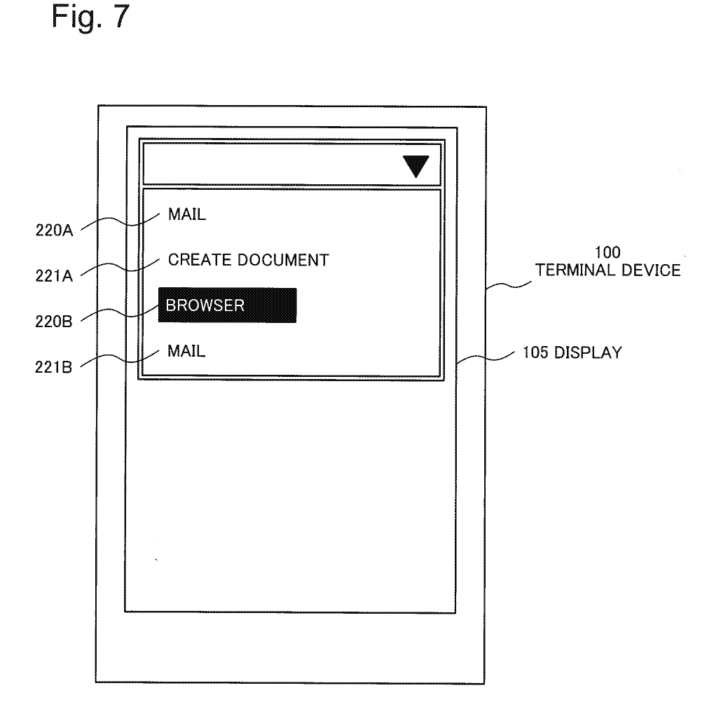

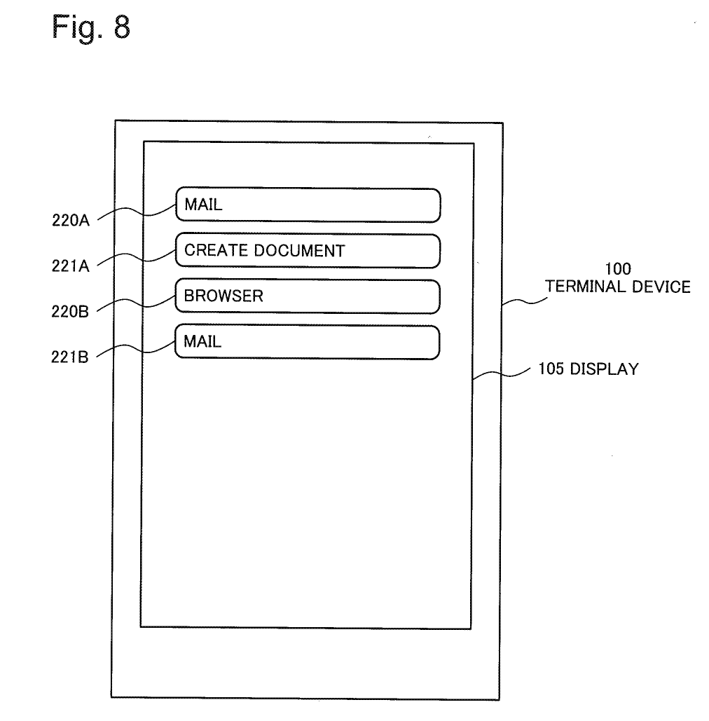

FIG. 6, FIG. 7, and FIG. 8 are diagrams illustrating an example of the menu screen to be displayed on the display 105 by the screen display unit 113.

As illustrated in FIG. 6, the screen display unit 113 may display, on the display 105, the menu screen including respective instruction means for instructing to execute applications (AP220A and AP221A) to be executed on the node 200A, and applications (AP220B and AP221B) to be executed on the node 200B. In the example of the menu screen illustrated in FIG. 6, the instruction means is implemented by combination of a radio button, and an object indicating “execution”.

As illustrated in FIG. 7, the screen display unit 113 may display, on the display 105, the menu screen including respective instruction means capable of instructing to execute the applications (AP220A and AP221A) to be executed on the node 200A, and the applications (AP220B and AP221B) to be executed on the node 200B. In the example of the menu screen illustrated in FIG. 7, the instruction means is implemented by options to be displayed by a pull-down menu.

As illustrated in FIG. 8, the screen display unit 113 may display, on the display, the menu screen including respective objects capable of instructing to execute the applications (AP220A and AP221A) to be executed on the node 200A, and the applications (AP220B and AP221B) to be executed on the node 200B.

As described above, causing the screen display unit 113 to concurrently display the instruction means received from the node 200A and the instruction means received from the node 200B on one screen allows the user to perform switching between the nodes to be activated, and selecting an application to be executed by one-time operation. Reducing the number of times of operations leads to enhancement of the user's operability.

### Second Exemplary Embodiment

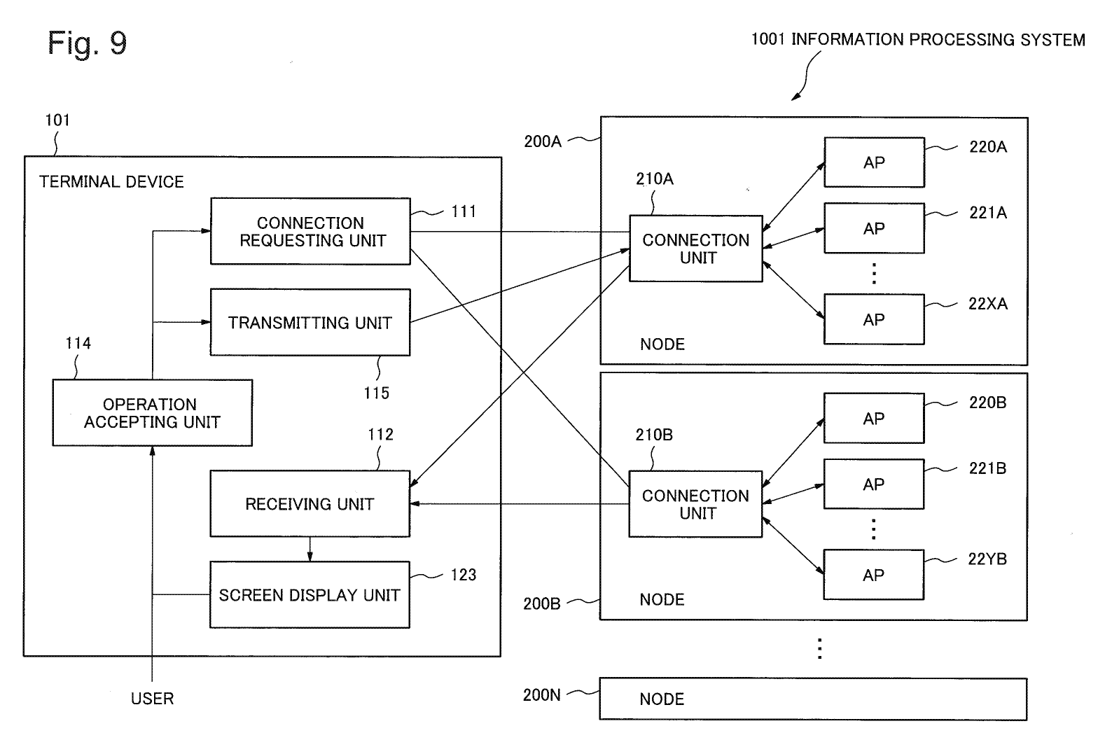

FIG. 9 is a block diagram illustrating the entire configuration of an information processing system 1001 provided with a terminal device 101 according to the second exemplary embodiment. Constituent elements substantially the same as the constituent elements illustrated in FIG. 1 are indicated by the same reference signs. As illustrated in FIG. 9, the terminal device 101 according to the second exemplary embodiment is provided with a screen display unit 123, in place of the screen display unit 113.

The screen display unit 123 displays an icon, and information for identifying the node 200 on which an application associated with the icon is to be executed in association with each other. The information for identifying the node 200 may be any information by which the user of the terminal device 101 can identify the node 200.

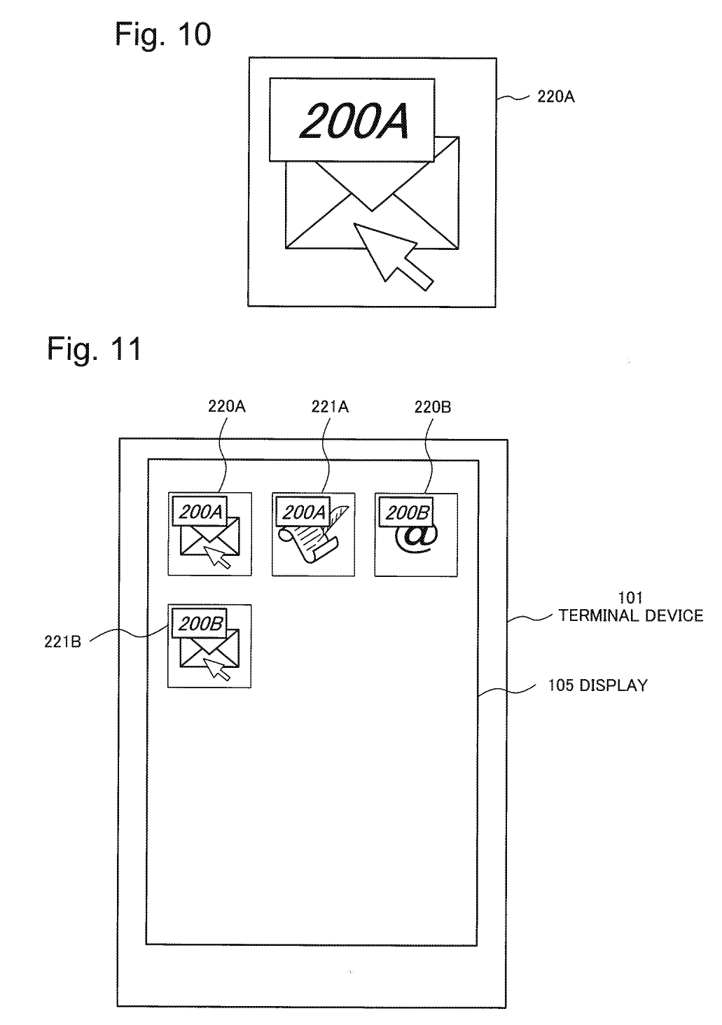

FIG. 10 is a diagram illustrating an example of the icon to be displayed on a menu screen by the screen display unit 123. The icon illustrated in FIG. 10 is configured such that all or at least a part of the information for identifying the node 200A is displayed in a superimposed manner in a display area representing the icon of the application 220A to be executed on the node 200A.

FIG. 11 is a diagram illustrating an example of the menu screen to be displayed on the display 105 by the screen display unit 123. As illustrated in FIG. 11, the screen display unit 123 displays, on the display 105, the menu screen including respective icons for use in instructing to execute applications (AP220A and AP221A) to be executed on the node 200A, and applications (AP220B and AP221B) to be executed on the node 200B. As illustrated in FIG. 11, information for identifying the node on which the application associated with the icon is to be executed is displayed in the superimposed manner with the icon on the menu screen.

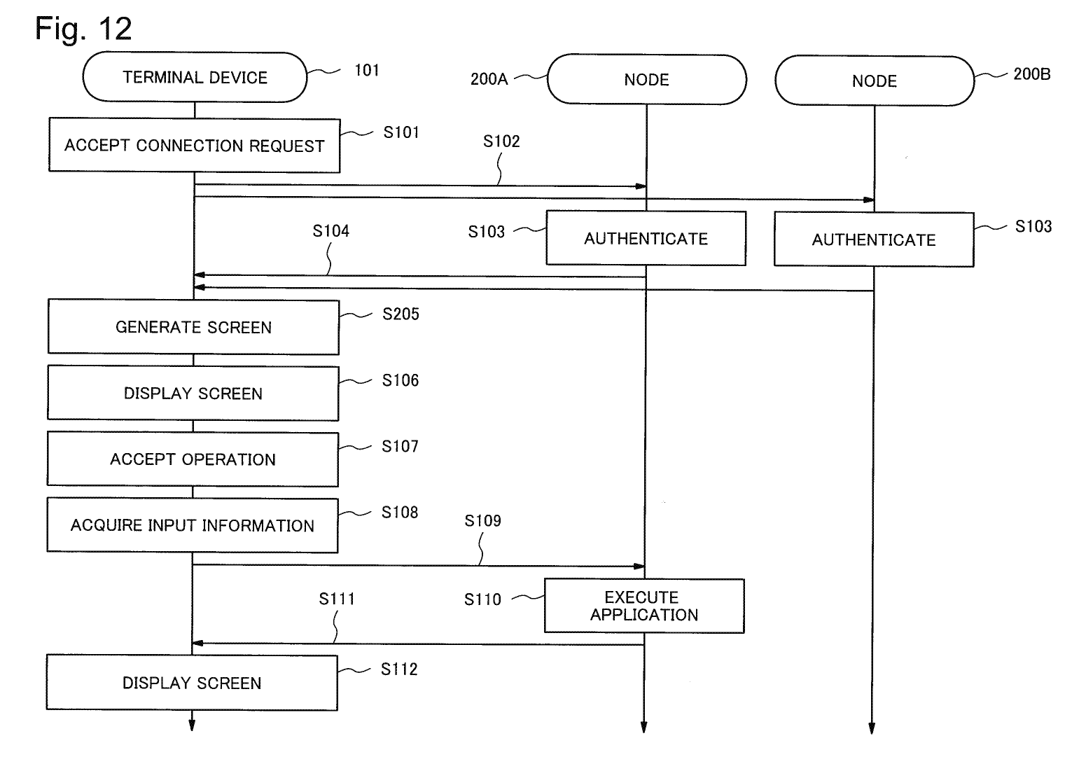

FIG. 12 is a sequence diagram illustrating the overall operation to be performed by the information processing system 1000A according to the second exemplary embodiment. The operations substantially the same as the operations illustrated in the sequence diagram of FIG. 4 are indicated by the same reference signs. As illustrated in FIG. 12, the operation to be performed by the information processing system 1000A according to the second exemplary embodiment is different from the operations in the first exemplary embodiment in a point that the terminal device 101 executes Step S205 in place of Step S105.

The operations of Step S101 to Step S104 illustrated in FIG. 12 are substantially the same as the operations illustrated in FIG. 4, and therefore, description thereof is omitted herein. The screen display unit 123 generates the menu screen including the received icon (S205). On the menu screen generated by the screen display unit 123, the icon, and information for identifying the node on which the application associated with the icon is to be executed are displayed in association with each other. The operations of Step S106 to Step S112 illustrated in FIG. 12 are substantially the same as the operations illustrated in FIG. 4, and therefore, description thereof is omitted herein.

As well as the first exemplary embodiment, the terminal device 101 according to the second exemplary embodiment is capable of enhancing the user's operability when the user operates a plurality of applications to be executed on each of the plurality of nodes, using one terminal device.

Further, with use of the menu screen to be displayed by the terminal device 101 according to the second exemplary embodiment, the user can discriminate which application 220 is to be executed on which one of the nodes 200.

### Modified Example of Second Exemplary Embodiment

Displaying information capable of identifying the node on the icon in the superimposed manner is merely an example of the operation to be performed by the screen display unit 123.

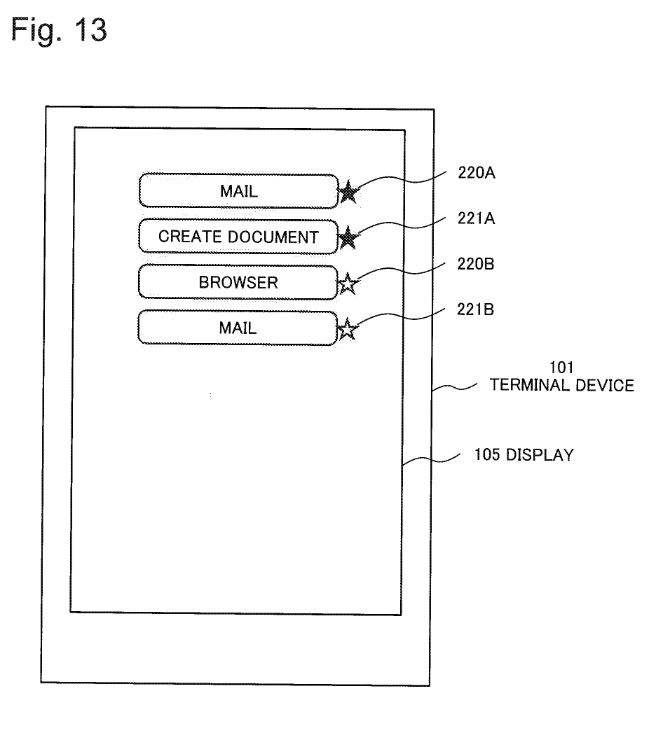

FIG. 13 is a diagram illustrating an example of the screen to be displayed by the screen display unit 123. As illustrated in FIG. 13, the screen display unit 123 displays, on the display 105, the menu screen including the respective objects described in the following. Operating each of the objects allows the user to instruct to execute the application associated with the object.
Applications (AP220A and AP221A) to be executed on the node 200A
Applications (AP220B and AP221B) to be executed on the node 200B

As illustrated in FIG. 13, objects, and information (black star symbol or white star symbol) for identifying each node on which the application associated with each object is to be executed are displayed on the menu screen in association with each other. On the menu screen illustrated in FIG. 13, information for identifying the node on which the application associated with each object is to be executed is displayed with use of the black star symbol or the white star symbol. The black star symbols illustrated in FIG. 13 represent that the application associated with the object attached with the black star symbol is executed on the node 200A. The white star symbols illustrated in FIG. 13 represent that the application associated with the object attached with the white star symbol is executed on the node 200B. The correlation between the black star symbol or the white star symbol, and the node 200 on which the application is to be executed may be explicitly displayed on the screen, or may not be explicitly displayed on the screen.

### Third Exemplary Embodiment

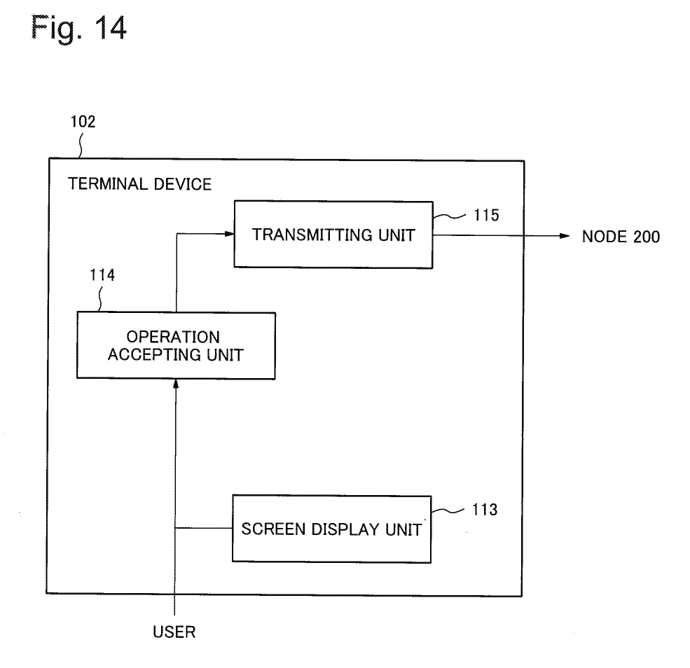

FIG. 14 is a block diagram illustrating a configuration of a terminal device 102 according to the third exemplary embodiment.

The terminal device 102 illustrated in FIG. 14 is provided with the screen display unit 113, the operation accepting unit 114, and the transmitting unit 115.

The screen display unit 113 displays the screen including the instruction means for instructing to execute the application to be executed on the first node out of a plurality of nodes, and the instruction means for instructing to execute the application to be executed on the second node out of the plurality of nodes. The operation accepting unit 114 accepts the operation with respect to the instruction means included in the screen. The transmitting unit 115 transmits the command for instructing to execute the application associated with the operated instruction means to the node on which the application is to be executed.

The terminal device 102 according to the third exemplary embodiment is capable of enhancing the user's operability when the user operates a plurality of applications to be executed on each of the plurality of nodes, using one terminal device.

The exemplary embodiments of the present invention are described above. The exemplary embodiments, however, are provided to make it easy to understand the present invention, and are not be construed to limit the present invention. The present invention may be modified or altered, as far as such modifications and alterations do not depart from the gist of the invention, and the equivalents of the modifications and alterations are also included in the present invention.

This application is based upon and claims the benefit of priority from Japanese patent application No. 2013-076734, filed on Apr. 2, 2013, the disclosure of which is incorporated herein in its entirety by reference.

### INDUSTRIAL APPLICABILITY

The present invention is applicable to a terminal device, a terminal device control method, and a program as application examples.

### REFERENCE SIGNS LIST

1000 Information processing system

1001 Information processing system

100 Terminal device

101 Terminal device

102 Terminal device

103 Communication interface

104 Input device

105 Display

106 CPU

107 Storage device

111 Connection requesting unit

112 Receiving unit

113 Screen display unit

114 Operation accepting unit

115 Transmitting unit

123 Screen display unit

200 Node

210 Connection unit

220 Application

What is claimed is:

1. A terminal device communicatively connected to a plurality of nodes, comprising:
a screen display unit that displays one screen including an instruction unit instructing to execute an application to be executed on a first node out of the plurality of nodes, and an instruction unit instructing to execute an application to be executed on a second node out of the plurality of nodes;
an operation accepting unit that accepts an operation with respect to the instruction unit included in the screen; and
a transmitting unit that transmits a command for instructing to execute the application associated with the operated instruction unit to the node on which the application is to be executed.

2. The terminal device according to claim 1, wherein at least both of the instruction unit instructing to execute the application to be executed on the first node, and the instruction unit instructing to execute the application to be executed on the second node are displayed on the screen.

3. The terminal device according to claim 1, wherein the instruction unit instructing to execute a first application out of a plurality of applications to be executed on the first node, the instruction unit instructing to execute a second application out of the plurality of applications to be executed on the first node, and the instruction unit instructing to execute an application to be executed on the second node are displayed on the screen.

4. The terminal device according to claim 1, further comprising
a receiving unit that receives the instruction unit from each of the plurality of nodes,
wherein the screen display unit displays the instruction unit received by the receiving unit.

5. The terminal device according to claim 1, wherein the instruction unit is an icon.

6. The terminal device according to claim 1, wherein the instruction unit instructing to execute the application, and information for identifying the node on which the application is to be executed are displayed on the screen in association with each other.

7. The terminal device according to claim 6, wherein at least a part of the information relating to the node is displayed on the screen in a display area representing the instruction unit in a superimposed manner.

8. The terminal device according to claim 1, further comprising
a connection requesting unit that transmits a connection request to the plurality of nodes in response to accepting the connection request,
wherein the screen display unit displays the screen based on a reply to the connection request transmitted by the connection requesting unit.

9. A method for controlling a terminal device connected communicatively to a plurality of nodes, the method comprising:
displaying one screen including instruction unit instructing to execute an application to be executed on a first node out of the plurality of nodes, and instruction unit instructing to execute an application to be executed on a second node out of the plurality of nodes;
accepting an operation with respect to the instruction unit included in the screen; and
transmitting a command for instructing to execute the application associated with the operated instruction unit to the node on which the application is to be executed.

10. A non-transitory computer-readable storage medium stored with a program which causes a terminal device connected communicatively to a plurality of nodes to execute:
processing of displaying one screen including instruction unit instructing to execute an application to be executed on a first node out of the plurality of nodes, and instruction unit instructing to execute an application to be executed on a second node out of the plurality of nodes;
processing of accepting an operation with respect to the instruction unit included in the screen; and
processing of transmitting a command for instructing to execute the application associated with the operated instruction unit to the node on which the application is to be executed.
